(19) United States
(12) Patent Application Publication
(10) Pub. No.: US 2024/0071245 A1
(43) Pub. Date: Feb. 29, 2024

(54) AR CONTENT DISPLAY DEVICE, AR CONTENT DISPLAY SYSTEM, AR CONTENT DISPLAY METHOD AND PROGRAM

(71) Applicant: Mitsubishi Electric Corporation, Chiyoda-ku, Tokyo (JP)

(72) Inventor: Genta KITTAKA, Chiyoda-ku, Tokyo (JP)

(73) Assignee: Mitsubishi Electric Corporation, Chiyoda-ku, Tokyo (JP)

(21) Appl. No.: 18/261,415

(22) PCT Filed: Nov. 2, 2021
(86) PCT No.: PCT/JP2021/040466

§ 371 Date: Jul. 13, 2023

(30) Foreign Application Priority Data
Mar. 9, 2021 (JP) 2021-037344

(51) Int. Cl. G09B 5/06; G06Q 10/0639; G06T 19/00; G06V 10/764

(52) U.S. Cl. CPC G09B 5/065; G06Q 10/06398; G06T 19/006; G06V 10/764

(57) ABSTRACT

An augmented reality (AR) content display device includes operation information generating circuitry to generate operation information indicating an operator action performed by an operator based on acquired image data, a storage device to store a variety of information, skill calculating circuitry to calculate, as a skill level of the operator, based on the latest operation information and the model operation information about a process including the operator action indicated by the operation information, a difference in the operator action between the operator and the model operator, AR marker determining circuitry to determine an AR marker to be assigned to each operation task in the process based on information indicating the skill level, and AR marker outputting circuitry to output AR marker information indicating the determined AR marker to a wearable device that displays AR content.

### TECHNICAL FIELD

The present disclosure relates to an augmented reality (AR) content display device, an AR content display system, an AR content display method, and a program.

### BACKGROUND ART

The recent advancement of head-mounted displays and the emergence of applications for creating AR content have increased the interest in using such AR techniques at manufacturing sites to provide operation instructions and skill training. However, creating AR content that represents operation tasks for manufacturing products as well as operator actions performed by model operators involves expert knowledge and design work-hours. The created content is to be updated when the operation tasks are revised. Techniques have thus been awaited for automatically creating AR content to provide operation instructions and skill training.

Patent Literature 1 describes a content creation system that creates training content based on, for example, operation tasks for virtual reality or AR and operator actions performed by a model operator, evaluates the series of operations of an operator based on the training content, and updates the content.

### CITATION LIST

### Patent Literature

Patent Literature 1: Unexamined Japanese Patent Application Publication No. 2020-3707

### SUMMARY OF INVENTION

### Technical Problem

The technique described in Patent Literature 1 displays the AR content independently of the skill level of the operator. The technique used in providing operation instructions and skill training can increase the time taken to perform operations or learn skills depending on the skill level of the operator and can be inefficient.

An objective of the present disclosure is to improve the efficiency of performing operations and learning skills at sites at which operation instructions and skill training are provided by displaying AR content.

### Solution to Problem

To achieve the above objective, an argument reality content display device according to an aspect of the present disclosure includes an operation information generator, a storage, a skill calculator, an augmented reality marker determiner, and an augmented reality marker outputter. The operation information generator acquires image data from a wearable device worn by an operator and generates operation information indicating an operator action performed by the operator based on the image data. The wearable device displays augmented reality content corresponding to an augmented reality marker. The storage stores the operation information, model operation information indicating an operator action performed by a model operator, and augmented reality marker information indicating an augmented reality marker. The skill calculator calculates, as a skill level of the operator, based on a latest set of the operation information and the model operation information about a process including the operator action indicated by the operation information, a difference in the operator action between the operator and the model operator in each operation task in the process. The skill calculator generates skill level information indicating the skill level of the operator. The augmented reality marker determiner determines an augmented reality marker to be assigned to each operation task in the process based on the skill level information. The augmented reality marker outputter outputs to the wearable device the augmented reality marker information indicating the augmented reality marker determined by the augmented reality marker determiner.

### Advantageous Effects of Invention

The technique according to the above aspect of the present disclosure improves the efficiency of performing operations and learning skills by displaying AR content based on the skill level of an operator at sites at which operation instructions and skill training are provided by displaying AR content.

### BRIEF DESCRIPTION OF DRAWINGS

FIG. 1 is a block diagram of an AR content display system according to an embodiment;

FIG. 2 is a table of example position coordinate data in the embodiment;

FIG. 3 is a table of example counts of operator actions in each class in the embodiment;

FIG. 4 is a table of example counts of irrelevant actions in the embodiment;

FIG. 5 is a flowchart of an AR content display process in the embodiment;

FIG. 6 is a flowchart of a process of operation class-based skill level calculation in the embodiment;

FIG. 7 is a flowchart of a process of irrelevant action-based skill level calculation in the embodiment; and

FIG. 8 is a block diagram of an AR content display device according to the embodiment, illustrating an example hardware configuration.

### DESCRIPTION OF EMBODIMENTS

An augmented reality (AR) content display device, an AR content display system, an AR content display method, and a program according to an embodiment are described below in detail with reference to the drawings. In the drawings, the same reference signs denote the same or corresponding components. In the present embodiment described below, AR content is displayed on a wearable device worn by an operator to provide operation instructions and skill training at a manufacturing site.

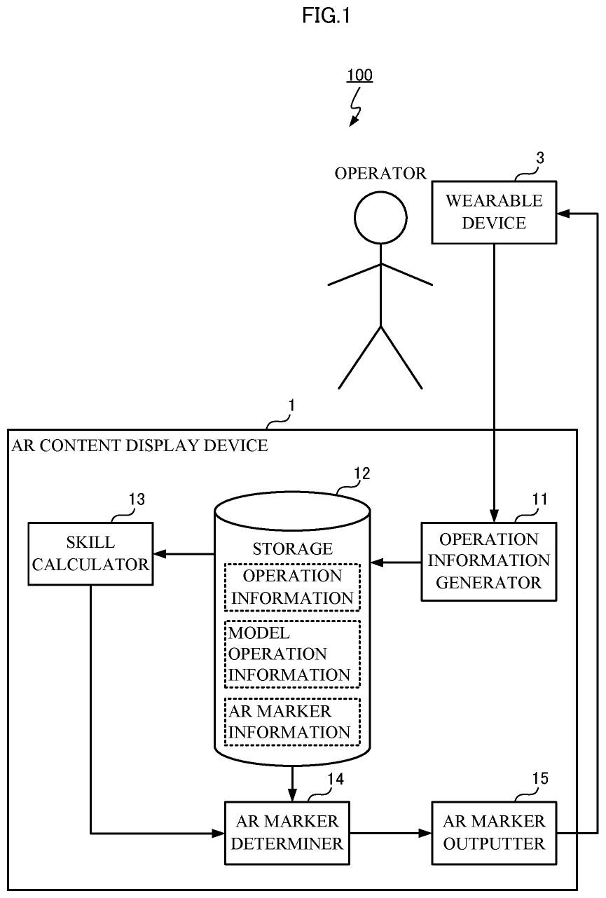

The configuration of an AR content display system 100 according to the embodiment is described with reference to FIG. 1. As illustrated in FIG. 1, the AR content display system 100 includes an AR content display device 1 and a wearable device 3 wearable by an operator. The AR content display device 1 displays AR content on the wearable device 3. The AR content display device 1 and the wearable device 3 are connected, for example, wirelessly.

The wearable device 3 is, for example, a head-mounted display, a smartphone, a tablet, or a webcam with an image capturing function. The wearable device 3 transmits image data indicating the captured image to the AR content display device 1. The AR content display device 1 generates operation information indicating an operator action performed by the operator based on the received image data. The AR content display device 1 compares the latest operation information about the operator with model operation information indicating the operator action performed by a model operator, determines an AR marker for AR content based on the difference acquired by the comparison, and transmits the AR marker to the wearable device 3. The wearable device 3 displays the AR content corresponding to the received AR marker.

The AR content display device 1 includes an operation information generator 11 that acquires image data from the wearable device 3 and generates operation information based on the image data and a storage 12 that stores operation information generated by the operation information generator 11, model operation information, and AR marker information indicating an AR marker. The model operation information and the AR marker information may be acquired from, for example, a production control system that controls the manufacture of products. The AR content display device 1 also includes a skill calculator 13 that calculates, as the skill level of the operator, the difference in the operator action between the operator and a model operator based on the latest operation information and the model operation information, an AR marker determiner 14 that determines an AR marker based on the skill level of the operator, and an AR marker outputter 15 that outputs the determined AR marker to the wearable device 3.

The operation information generator 11 analyzes image data acquired from the wearable device 3 and generates operation information indicating the operator action performed by the operator. More specifically, the operation information generator 11 detects the position coordinates of an object in the image indicated by the image data. Examples of the object include the head of the operator, the eyes of the operator, and the hands of the operator, a product, and parts. The image data acquired from the wearable device 3 may include data acquired with, for example, an accelerometer, an eye tracker, or a motion camera included in the wearable device 3. The operation information generator 11 specifies the process and the operation task started by the operator. The process and the operation task started by the operator are specified by, for example, prestoring the change of the position coordinates of an object indicating the operator action for each operation task and specifying, as being started, the process and the operation task with the change of the position coordinates matching the change of the position coordinates indicated by the new operation information sequentially stored in the storage 12. The process refers to the operation from the start to the end in each stage of manufacturing of a product, such as tightening a screw or attaching part a to part b. The operation task refers to the task of each operation included in the process. The operation information generator 11 generates operation information indicating the operator, the process and the operation task being performed by the operator, and the position coordinates of the object acquired at predetermined time intervals.

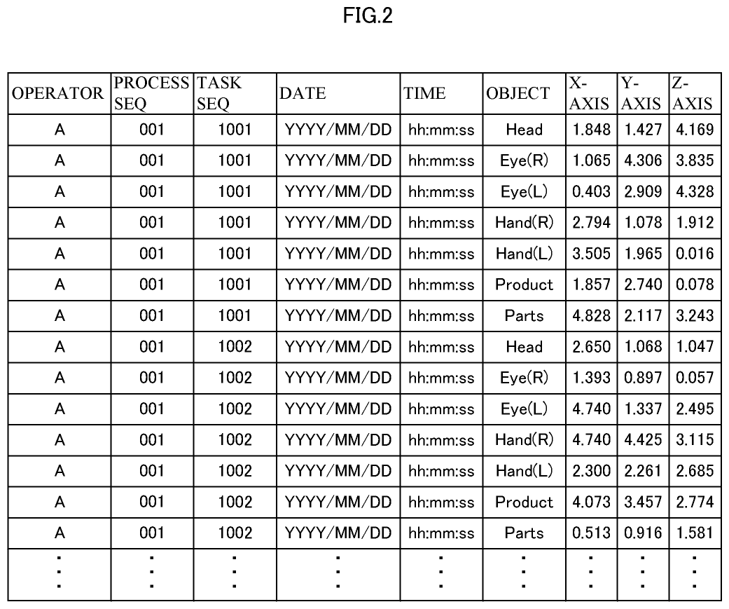

The operation information generated by the operation information generator 11 is described with reference to FIG. 2. In the example of FIG. 2, the operation information includes items including Operator indicating the operator, Process SEQ indicating the process being performed by the operator, Task SEQ indicating the operation task being performed by the operator, Date indicating the date on which the image data is acquired, Time indicating the time at which the image data is acquired, Object indicating the object, X-axis indicating the coordinate of the object on X-axis, Y-axis indicating the coordinate of the object on Y-axis, and Z-axis indicating the coordinate of the object on Z-axis. The entry Head indicates the head of the operator, Eye (R) indicates the right eye of the operator, Eye (L) indicates the left eye of the operator, Hand (R) indicates the right hand of the operator, Hand (L) indicates the left hand of the operator, Product indicates the product, and Parts indicates the parts.

Referring back to FIG. 1, after specifying the process and the operation task started by the operator, the operation information generator 11 sequentially stores the operation information generated at predetermined time intervals into the storage 12. The model operation information prestored in the storage 12 is data in the same format as the operation information. The model operation information indicates the position coordinates of the object at predetermined time intervals in each operation task included in each process performed by a model operator in the past.

Upon storing of new operation information into the storage 12, the skill calculator 13 calculates, as the skill level of the operator, the difference in the operator action between the operator and the model operator based on the latest operation information about the process and the operation task indicated by the new operation information and the model operation information about the same process and operation task. The skill level is either a skill level based on operation classification or a skill level based on an irrelevant action.

The skill level based on operation classification is first described. The skill calculator 13 classifies the operator action performed per predetermined time interval into one of four classes, or a main operation, an auxiliary operation, a transporting operation, and pausing, based on the position coordinates (on X-axis, Y-axis, and Z-axis) of the head, the hands, and the eyes of the operator as well as the position coordinates (on X-axis, Y-axis, and Z-axis) of the product at predetermined time intervals included in the latest operation information. The skill calculator 13 classifies the operator action as pausing when the position coordinates of the operator hands remain unchanged. When the position coordinates of the operator hands have changed, the skill calculator 13 calculates the horizontal displacement of the position coordinates of the operator head using Formula 1 below to determine whether the operator has changed position. The predetermined time interval is from time i−1 to time i.

\sqrt{(HXᵢ−HXᵢ₋₁)²+(HZᵢ−HZᵢ₋₁)}≥0.3m (1)

HXi is the position coordinates of the head on X-axis at time I, and Hzi is the position coordinates of the head on Z-axis at time i. When the horizontal (X-Z coordinates) displacement is greater than or equal to a threshold of 0.3 m, the skill calculator 13 determines that the operator has changed position. When the horizontal displacement is less than the threshold of 0.3 m, the skill calculator 13 determines that the operator has not changed position. The threshold of 0.3 m in Formula 1 is an example and may be another value.

When determining that the operator has not changed position, the skill calculator 13 classifies the operator action as the main operation. When determining that the operator has changed position, the skill calculator 13 calculates the displacement of the position coordinates of the product using Formula 2 below to determine whether the product has been displaced.

\sqrt{(PXᵢ−PXᵢ₋₁)²+(PYᵢ−PYᵢ₋₁)²+(PZᵢ−PZᵢ₋₁)²}≥0.5m. (2)

Pxi is the position coordinates of the product on X-axis at time i, Pyi is the position coordinates of the product on Y-axis at time i, and Pzi is the position coordinates of the product on Z-axis at time i. When the triaxial displacement of the position coordinates of the product is greater than or equal to a threshold of 0.5 m, the skill calculator 13 determines that the product has been displaced. When the displacement is less than the threshold of 0.5 m, the skill calculator 13 determines that the product is not displaced. The threshold of 0.5 m in Formula 2 is an example and may be another value.

When determining that the product has not been displaced, the skill calculator 13 classifies the operator action as an auxiliary operation. When determining that the product has been displaced, the skill calculator 13 classifies the operator action as a transporting operation. Classifying the operator actions performed per predetermined time interval into one of the four classes, or a main operation, an auxiliary operation, a transporting operation, and pausing, is referred to as an operation class determination process. The skill calculator 13 performs the operation class determination process at predetermined time intervals. When, for example, performing the determination about an operation task that takes 100 seconds at intervals of five seconds, the skill calculator 13 performs the operation class determination process 20 times (i≤20). The skill calculator 13 counts operator actions in each class performed in the operation task and calculates the rate using Formula 3.

$$\begin{matrix}The rate of operator \\ actions in a class\end{matrix} = \frac{\begin{matrix}The count of operator actions \\ in the class\end{matrix}}{\begin{matrix}the count of determination \\ performed ( operation duration \div \\ predetermined time interval )\end{matrix}} \qquad ( 3 )$$

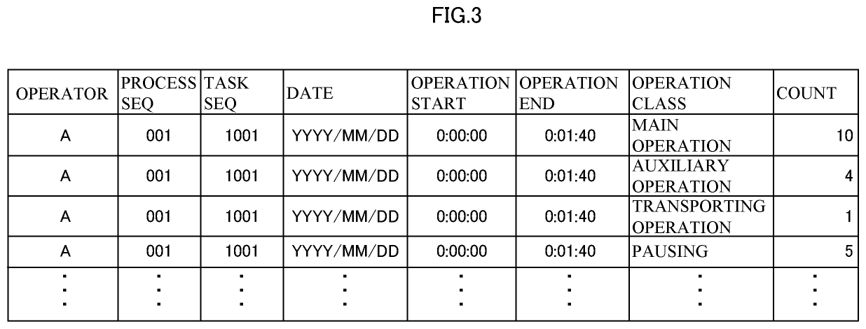

The count of operator actions in each class is described with reference to FIG. 3. FIG. 3 illustrates example counts of operator actions performed by an operator A in each class in a task SEQ 1001 included in a process SEQ 001. The task SEQ 1001 in the process SEQ 001 includes the main operation performed ten times, an auxiliary operation performed four times, a transporting operation performed once, and pausing performed five times by the operator A.

The skill calculator 13 also counts, for the model operation information about the model operator, operator actions in each class performed in the same operation task in the same process and calculates the rate using Formula 3. The skill calculator 13 calculates, as the skill level of the operator, the difference between the rate of operator actions in a class calculated based on the operation information and the rate of operator actions in the class calculated based on the model operation information. A greater difference between the rate of operator actions in a class calculated based on the operation information and the rate of operator actions in the class calculated based on the model operation information indicates a lower skill level of the operator. The difference between the rate of operator actions in a class calculated based on the operation information and the rate of operator actions in the class calculated based on the model operation information is hereafter referred to as an operation class-based skill level. The skill calculator 13 transmits information indicating the operation class-based skill level for each operation task in the process to the AR marker determiner 14. The information indicating the operation class-based skill level is an example of skill level information.

The skill level based on irrelevant actions is described. Typical known irrelevant actions at manufacturing sites include walking, carrying, stretching, squatting, striking, and searching. The skill calculator 13 counts such irrelevant actions in an operation task and calculates the rate.

The skill calculator 13 first calculates the horizontal displacement of the position coordinates of the operator head using Formula 1 to determine whether the operator head has moved horizontally. When determining that the operator head has moved horizontally and that the position coordinates of the hands have changed, the skill calculator 13 calculates the horizontal displacement of the position coordinates of the operator hands using Formulas 4 and 5 to determine whether the operator hands have moved horizontally.

\sqrt{(LHXᵢ−LHXᵢ₋₁)²+(LHZᵢ−LHZᵢ₋₁)²}≥0.3m (4)

\sqrt{(RHXᵢ−RHXᵢ₋₁)²+(RHZᵢ−RHZᵢ₋₁)²}≥0.3m (5)

LHXi and LHZi are the respective position coordinates on X-axis and Z-axis of the left hand at time I, and RHXi and RHZi are the respective position coordinates on X-axis and Z-axis of the right hand at time i. When the horizontal (X-Z coordinates) displacement is greater than or equal to the threshold of 0.3 m, the skill calculator 13 determines that the hand has moved horizontally. When the displacement is less than the threshold of 0.3 m, the skill calculator 13 determines that the hand has not moved horizontally. The threshold of 0.3 m in Formulas 4 and 5 is an example and may be another value. When either Formula 4 or 5 is satisfied, the skill calculator 13 determines that the operator hand has moved horizontally.

The skill calculator 13 calculates a vertical displacement of the position coordinates of the operator hands using Formulas 6 and 7 to determine whether the operator hands have moved vertically.

|LHYᵢ−LHYᵢ₋₁|≥0.3m (6)

|RHYᵢ−RHYᵢ₋₁|≥0.3m (7)

LHYi is the position coordinate of the left hand on Y-axis at time i, and RHYi is the position coordinate of the right hand on Y-axis at time i. When the vertical (Y-coordinate) displacement is greater than or equal to the threshold of 0.3 m, the skill calculator 13 determines that the hand has moved vertically. When the displacement is less than the threshold of 0.3 m, the skill calculator 13 determines that the hand has not moved vertically. The threshold of 0.3 m in Formulas 6 and 7 is an example and may be another value. When either Formula 6 or 7 is satisfied, the skill calculator 13 determines that the operator hand has moved vertically.

When determining that the operator hand has moved both horizontally and vertically, the skill calculator 13 determines that the operator has moved the hand in the direction with a greater displacement. When the displacements are the same in both directions, the skill calculator 13 determines that the operator has moved the hand vertically. When determining that the operator has moved the hand vertically and either LHYi−LHYi−1<0 or RHYi−RHYi−1<0, the skill calculator 13 determines that a striking action has occurred.

When determining that the operator hand has moved horizontally, the skill calculator 13 determines whether the product has been displaced using Formula 2. When determining that the product has been displaced, the skill calculator 13 determines that a carrying action has occurred. When determining that the product has not been displaced, the skill calculator 13 determines that a walking action has occurred.

When determining that the operator head has moved horizontally without a change in the position coordinates of the hands, the skill calculator 13 calculates the displacement of the position coordinates of the operator eyes using Formulas 8 and 9 to determine whether the gaze direction of the operator has changed.

\sqrt{(LEXᵢ−LEXᵢ₋₁)²+(LEYᵢ−LEYᵢ₋₁)²+(LEZᵢ−LEZᵢ₋₁)²}≥0.01m (8)

\sqrt{(REXᵢ−REXᵢ₋₁)²+(REYᵢ−REYᵢ₋₁)²+(REZᵢ−REZᵢ₋₁)²}≥0.01m (9)

LEXi, LEYi, and LEZi are the respective position coordinates of the left eye on X-axis, Y-axis, and Z-axis at time i, and REXi, REYi, and REZi are the respective position coordinates of the right eye on X-axis, Y-axis, and Z-axis at time i. When the triaxial displacement is greater than or equal to the threshold of 0.01 m, the skill calculator 13 determines that the gaze direction has changed. When the displacement is less than the threshold of 0.01 m, the skill calculator 13 determines that the gaze direction remains unchanged. The threshold of 0.01 m in Formulas 8 and 9 is an example and may be another value. When either Formula 8 or 9 is satisfied, the skill calculator 13 determines that the gaze direction of the operator has changed. When determining that the gaze direction of the operator has changed, the skill calculator 13 determines that a searching action has occurred. When determining that the gaze direction remains unchanged, the skill calculator 13 determines that no irrelevant action has occurred.

When determining that the operator head has not moved horizontally, the skill calculator 13 calculates the vertical displacement of the position coordinates of the operator head using Formula 10 to determine whether the operator head has moved vertically.

Hyi is the position coordinate of the head on Y-axis at time i. When the vertical (Y-coordinate) displacement is greater than or equal to the threshold of 0.3 m, the skill calculator 13 determines that the operator head has moved vertically. When the displacement is less than the threshold of 0.3 m, the skill calculator 13 determines that the operator head has not moved vertically. The threshold of 0.3 m in Formula 10 is an example and may be another value.

|HYᵢ−HYᵢ₋₁|≥0.3m (10)

When determining that the operator head has not moved vertically, the skill calculator 13 determines that no irrelevant action has occurred. Upon determining that the operator head has moved vertically, the skill calculator 13 determines that a stretching action has occurred when Hyi−Hyi−1>0 and determines that a squatting action has occurred when Hyi−Hyi−1<0. The above process of determining whether any irrelevant action, walking, carrying, stretching, squatting, striking, or searching, has occurred is hereafter referred to as an irrelevant action determination process. The skill calculator 13 performs the irrelevant action determination process at predetermined time intervals. For example, when performing the determination about an operation task that takes 100 seconds at intervals of five seconds, the skill calculator 13 performs the irrelevant action determination process 20 times (i≤20). The skill calculator 13 counts each irrelevant action in the operation task and calculates the rate using Formula 11.

$$\begin{matrix}the rate of \\ problematic operation\end{matrix} = \frac{The count of problematic actions}{\begin{matrix}the count of determination \\ performed ( operation duration \div \\ predetermined time interval )\end{matrix}} \qquad ( 11 )$$

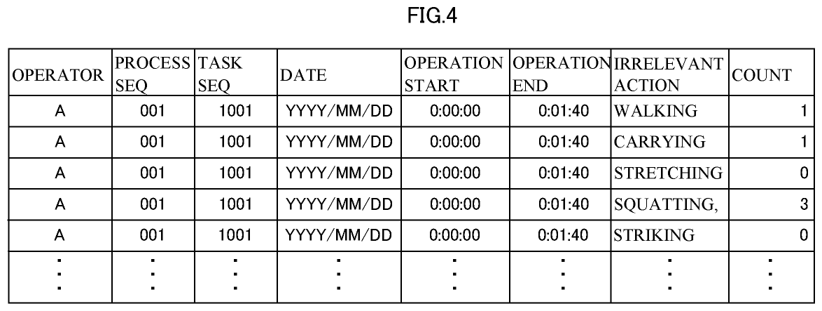

The count of each irrelevant action is described with reference to FIG. 4. FIG. 4 illustrates example counts of irrelevant actions in the task SEQ 1001 in the process SEQ 001. The task SEQ 1001 in the process SEQ 001 includes walking performed once, carrying performed once, and squatting performed three times by the operator A.

The skill calculator 13 also counts, for the model operation information about the model operator, the count of each irrelevant action in the same operation task in the same process, and calculates the rate using Formula 11. The skill calculator 13 calculates, as the skill level of the operator, the difference between the rate of each irrelevant action calculated based on the operation information and the rate of each irrelevant action calculated based on the model operation information. A greater difference between the rate of each irrelevant action calculated based on the operation information and the rate of each irrelevant action calculated based on the model operation information indicates a lower skill level of the operator. The difference between the rate of each irrelevant action calculated based on the operation information and the rate of each irrelevant action calculated based on the model operation information is hereafter referred to as an irrelevant action-based skill level. The skill calculator 13 transmits information indicating the irrelevant action-based skill level for each operation task in the process to the AR marker determiner 14. The information indicating irrelevant action-based skill level is an example of skill level information.

Upon receiving the information indicating the operation class-based skill level and the information indicating the irrelevant action-based skill level, the AR marker determiner 14 extracts the AR marker corresponding to each operation task in the process from the storage 12. The AR marker AR corresponding to each operation task in the process has the corresponding AR content and the display position predetermined based on, for example, the model operation information. The AR marker determiner 14 uses Formula 12 as an objective function and determines the AR marker to be assigned to the operation task to maximize the objective function based on the information indicating the operation class-based skill level or the information indicating the irrelevant action-based skill level.

$${\sum }_{p ∈ P} {\sum }_{\{ t , {t}^{′} \} ∈ T} {\sum }_{w ∈ W} {\sum }_{j ∈ {AR}_{p}} {a}_{pw} {b}_{{ptt}^{′}} {x}_{ptj} \qquad ( 12 )$$

P is a set of tasks p in a process, T is a set of operation durations of the tasks p in the process from time t to time t′ performed by a model operator, W is a set of irrelevant actions, Arp is a set of AR markers corresponding to the tasks p, and apw is the operation class-based skill level or the irrelevant action-based skill level in an operation task p.

Also, bptt′ is the rate of the difference in operation duration in the task p and is calculated with the formula below: Rate bptt′ of the difference in operation duration=(operation duration of the model operator in the task p—operation duration of the operator)/operation duration of the model operator in the task p, and xptj is a decision-making variable being 1 when an AR marker j is assigned to the task p and being 0 when the AR marker j is not assigned to the task p.

The AR marker determiner 14 determines the AR marker to be assigned to the operation task to satisfy a constraint on the memory capacity indicated with Formula 13 or a constraint on displaying AR content indicated with Formula 14 to maximize the objective function.

$${\sum }_{i ∈ T} {\sum }_{j ∈ {AR}_{p}} {M}_{j} {x}_{ptj} \leq {u}_{p} \qquad ( 13 )$$

$$p ∈ P$$

Formula 13 is a constraint for displaying AR content without exceeding the upper limit of the memory capacity of the wearable device 3. A memory capacity Mj is used to display the AR content of the AR marker j, and the wearable device 3 can use the memory capacity up to an upper limit up at a time. In Formula 13, the left side indicates the total use of memory capacity of the AR content corresponding to the AR marker to be assigned to the operation task p, and the right side indicates the upper limit of the memory capacity. Thus, the AR content can be displayed without exceeding the upper limit of the memory capacity usable at a time. More specifically, when the AR marker to be assigned is determined to satisfy the constraint indicated by Formula 13, the AR content can be displayed without decreasing the performance of the wearable device 3.

Although the memory capacity is sufficient, the upper limit may be set for the number of AR content items to be displayed to avoid lowering the visibility for the operator.

$${\sum }_{j ∈ {AR}_{ptf}} {x}_{ptj} \leq 1 \qquad ( 14 )$$

$$p ∈ P , t ∈ T , f ∈ F$$

Formula 14 is a constraint to avoid any overlapping display of AR content at the same position coordinates. F is a set of the position coordinates, and Arptf is a set of AR markers displayed at a position coordinate fat time tin the operation task p. In Formula 14, the left side indicates the count of AR markers displayed at the position coordinate fat time tin the operation task p, and is set to less than or equal to 1 to avoid any overlapping display of AR content. When f is removed from Formula 14, the number of AR content items displayed at the same time can be limited.

The AR marker determiner 14 solves a combinatorial optimization problem that maximizes the objective function using Formula 12 serving as an objective function and Formula 13 or 14 serving as a constraint, and determines the AR marker to be assigned to the operation task. To solve this combinatorial optimization problem, for example, a heuristic algorithm or a mathematical optimization solver that derives an optimal solution may be used. The AR marker determiner 14 determines whether the operation task assigned with the AR marker has been started based on new operation information stored in the storage 12. Upon determining that the operation task assigned with the AR marker has been started, the AR marker determiner 14 transmits AR marker information indicating the AR marker to the AR marker outputter 15.

The AR marker outputter 15 transmits the received AR marker information to the wearable device 3. The wearable device 3 displays the AR content corresponding to the AR marker indicated by the received AR marker information. Determining the AR marker to be assigned to an operation task to satisfy the constraint indicated by Formula 13 or 14 and to maximize the objective function indicated by Formula 12 allows the AR content to be displayed preferentially for the operation task with a higher operation class-based skill level or a higher irrelevant action-based skill level, or more specifically for the operation task for which the skill level of the operator is low.

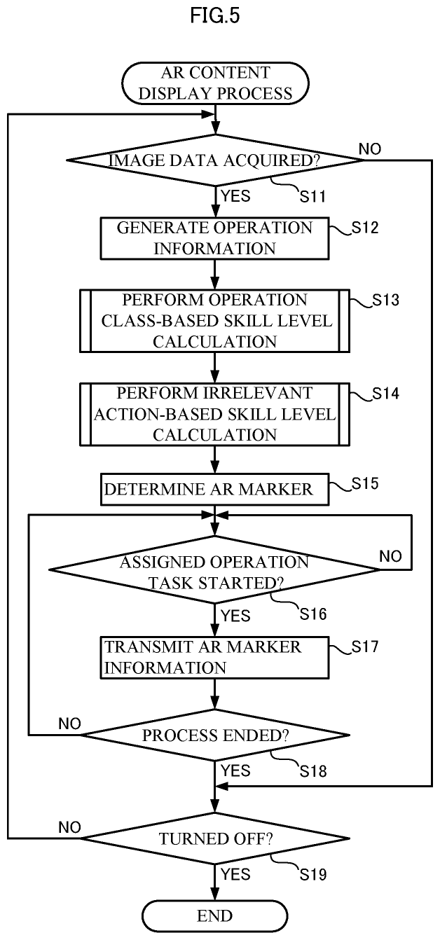

The process performed by the AR content display device 1 is described with reference to FIGS. 5 to 7. The AR content display process illustrated in FIG. 5 starts when the AR content display device 1 is turned on. When the operation information generator 11 in the AR content display device 1 acquires no image data from the wearable device 3 (NO in step S11), the processing advances to step S19. When acquiring image data from the wearable device 3 (YES in step S11), the operation information generator 11 specifies the process and the operation task started by the operator based on the image data and generates operation information (step S12). Step S12 is an example of acquiring image data and generating operation information. After specifying the process and the operation task started by the operator, the operation information generator 11 sequentially stores the operation information generated into the storage 12 at predetermined time intervals.

In the example of FIG. 2, the operation information includes items including Operator indicating the operator, Process SEQ indicating the process being performed by the operator, Task SEQ indicating the task being performed by the operator, Date indicating the date on which the image data is acquired, Time indicating the time at which the image data is acquired, Object indicating the object, X-axis indicating the coordinate of the object on X-axis, Y-axis indicating the coordinate of the object on Y-axis, and Z-axis indicating the coordinate of the object on Z-axis. The entry Head indicates the head of the operator, Eye (R) indicates the right eye of the operator, Eye (L) indicates the left eye of the operator, Hand (R) indicates the right hand of the operator, Hand (L) indicates the left hand of the operator, Product indicates the product, and Parts indicates the parts.

Referring back to FIG. 5, upon new operation information being stored into the storage 12, the skill calculator 13 performs the process of operation class-based skill level calculation (step S13) and generates information indicating the operation class-based skill level. The skill calculator 13 transmits the generated information indicating the operation class-based skill level to the AR marker determiner 14. The skill calculator 13 performs the process of irrelevant action-based skill level calculation (step S14) and generates information indicating the irrelevant action-based skill level. Steps S13 and S14 are examples of calculating a difference in the operator action as a skill level of the operator. The skill calculator 13 transmits the generated information indicating the irrelevant action-based skill level to the AR marker determiner 14. Steps S13 and S14 may be performed in any order.

Upon receiving the information indicating the operation class-based skill level and the information indicating the irrelevant action-based skill level, the AR marker determiner 14 extracts the AR marker corresponding to each operation task in the process from the storage 12. Using Formula 12 as an objective function, the AR marker determiner 14 determines the AR marker to be assigned to each operation task to maximize the objective function based on the information indicating the operation class-based skill level or the information indicating the irrelevant action-based skill level (step S15). Step S15 is an example of determining an augmented reality marker. The AR marker determiner 14 determines the AR marker that satisfies the memory capacity constraint indicated by Formula 13 or the AR content displaying constraint indicated by Formula 14 and maximizes the objective function. The AR marker determiner 14 determines whether the operation task assigned with the AR marker is started based on the new operation information stored in the storage 12 (step S16). When the operation task assigned with the AR marker has yet to be started (NO in step S16), the AR marker determiner 14 repeats step S16 to wait until the operation task assigned with the AR marker is started. When the operation task assigned with the AR marker has been started (YES in step S16), the AR marker determiner 14 transmits AR marker information indicating the AR marker to the AR marker outputter 15.

The AR marker outputter 15 transmits the received AR marker information to the wearable device 3 (step S17). Step S17 is an example of outputting augmented reality marker information. The wearable device 3 displays the AR content corresponding to the AR marker indicated by the received AR marker information.

The AR marker determiner 14 determines whether the process has ended based on new operation information stored in the storage 12 (step S18). When the process has yet to be ended (NO in step S18), the AR content display device 1 returns to step S16 to repeat steps S16 to S18. When the process has ended (YES in step S18) and the AR content display device 1 has not been turned off (NO in step S19), the AR content display device 1 returns to step S11 to repeat steps S11 to S19. When the AR content display device 1 has been turned off (YES in step S19), the display process ends.

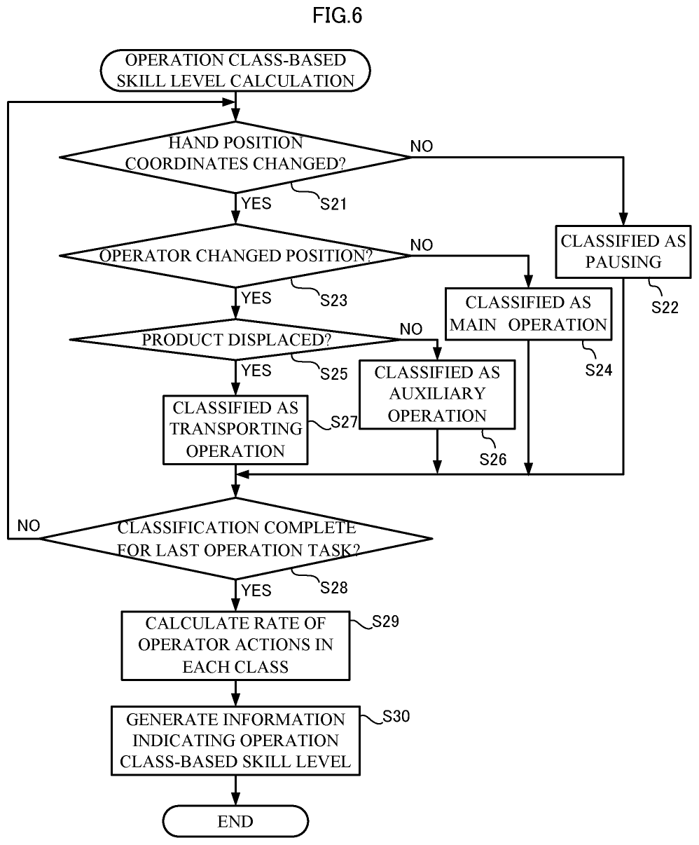

The process of the operation class-based skill level calculation defined in step S13 is described with reference to FIG. 6. The skill calculator 13 in the AR content display device 1 determines whether the position coordinates of the operator hands have changed based on the position coordinates (on X-axis, Y-axis, and Z-axis) of the head, the hands, and the eyes of the operator and the position coordinates (on X-axis, Y-axis, and Z-axis) of the product acquired at predetermined time intervals included in the latest operation information (step S21). When the position coordinates of the operator hands remain unchanged (NO in step S21), the skill calculator 13 classifies the operator action as pausing (step S22). When the position coordinates of the operator hands have changed (YES in step S21), the skill calculator 13 calculates the horizontal displacement of the position coordinates of the operator head using Formula 1 to determine whether the operator has changed position (step S23).

When determining that the operator has not changed position (NO in step S23), the skill calculator 13 classifies the operator action as the main operation (step S24). When determining that the operator has changed position (YES in step S23), the skill calculator 13 calculates the displacement of the position coordinates of the product using Formula 2 to determine whether the product has been displaced (step S25).

When determining that the product has not been displaced (NO in step S25), the skill calculator 13 classifies the operator action as an auxiliary operation (step S26). When determining that the product has been displaced (YES in step S25), the skill calculator 13 classifies the operator action as transporting (step S27). When the classification has yet to be complete for the last operation task (NO in step S28), the AR content display device 1 returns to step S21 to repeat steps S21 to S28. When the classification has been complete for the last operation task (YES in step S28), the skill calculator 13 counts operator actions in each class performed in the operation task and calculates the rate of each operator action using Formula 3 (step S29).

The count of operator actions in each class is described with reference to FIG. 3. FIG. 3 illustrates example counts of operator actions performed by the operator A in each class in the task SEQ 1001 in the process SEQ 001. The task SEQ 1001 in the process SEQ 001 includes the main operation performed ten times, an auxiliary operation performed four times, a transporting operation performed once, and pausing performed five times by the operator A.

Referring back to FIG. 6, the skill calculator 13 performs, also for the model operation information about the model operator, steps S21 to S28 in a similar manner. In each step, the operator is replaced with the model operator. The skill calculator 13 calculates, as the skill level of the operator, the difference between the rate of operator actions in each class calculated based on the operation information and the rate of operator actions in each class calculated based on the model operation information and generates information indicating the operation class-based skill level for each operation task in the process (step S30). A higher operation class-based skill level indicates a lower skill level of the operator. The skill calculator 13 transmits the information indicating the operation class-based skill level to the AR marker determiner 14 and ends the calculation process.

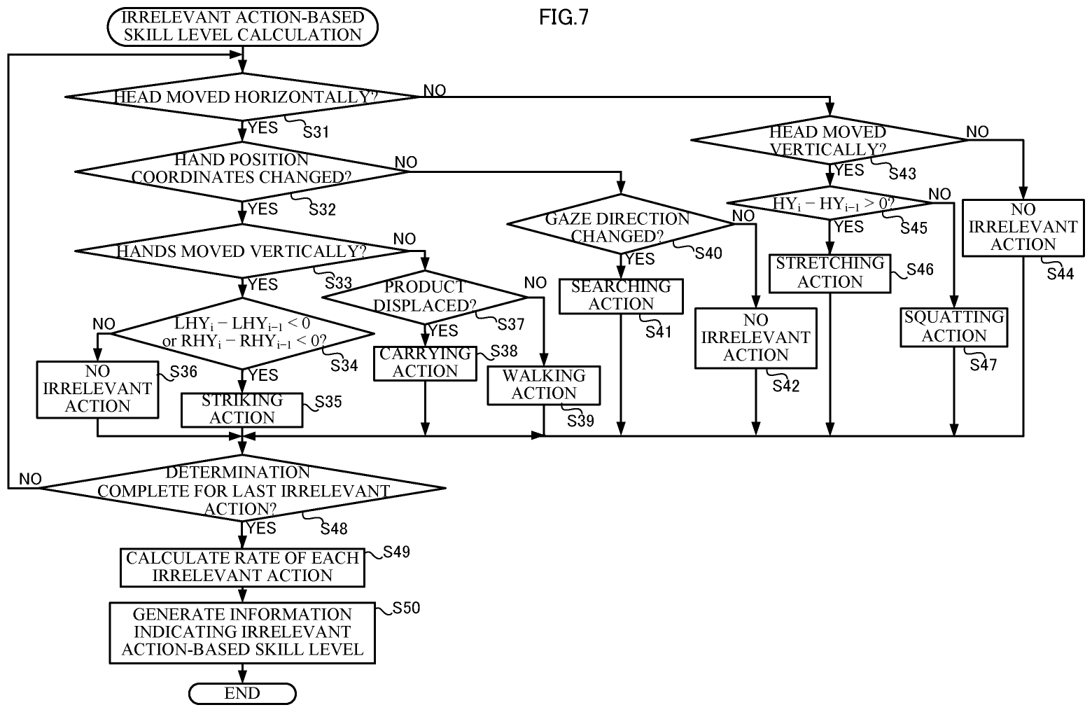

The process of the irrelevant action-based skill level calculation defined in step S14 is described with reference to FIG. 7. The AR content display device 1 calculates the horizontal displacement of the position coordinates of the operator head using Formula 1 to determine whether the operator head has moved horizontally (step S31). When determining that the operator head has moved horizontally (YES in step S31), the skill calculator 13 determines whether the position coordinates of the hands have changed (step S32). When the position coordinates of the hands have changed (YES in step S32), the skill calculator 13 calculates the horizontal and vertical displacements of the position coordinates of the operator hands using Formulas 4, 5, 6, and 7 to determine whether the operator has moved the hands vertically (step S33).

When determining that the operator has moved the hand vertically (YES in step S33), the skill calculator 13 determines whether either LHYi−LHYi−1<0 or RHYi−RHYi−1<0 is satisfied (step S34). When either LHYi−LHYi−1<0 or RHYi−RHYi−1<0 is satisfied (YES in step S34), the skill calculator 13 determines that a striking action has occurred (step S35). When neither LHYi−LHYi−1<0 nor RHYi−RHYi−1<0 is satisfied (NO in step S34), the skill calculator 13 determines that no irrelevant action has occurred (step S36).

When not determining that the operator has moved the hands vertically (NO in step S33), or in other words, when determining that the operator has moved the hands horizontally, the skill calculator 13 determines whether the product has been displaced using Formula 2 (step S37). When determining that the product has been displaced (YES in step S37), the skill calculator 13 determines that a carrying action has occurred (step S38). When determining that the product has not been displaced (NO in step S37), the skill calculator 13 determines that a walking action has occurred (step S39).

When the position coordinates of the hands remain unchanged (NO in step S32), the skill calculator 13 calculates the displacements of the position coordinates of the operator eyes using Formulas 8 and 9 to determine whether the gaze direction of the operator has changed (step S40). When determining that the gaze direction of the operator has changed (YES in step S40), the skill calculator 13 determines that a searching action has occurred (step S41). When determining that the gaze direction remains unchanged (NO in step S40), the skill calculator 13 determines that no irrelevant action has occurred (step S42).

When determining that the operator head has not moved horizontally (NO in step S31), the skill calculator 13 calculates the vertical displacement of the position coordinates of the operator head using Formula 10 to determine whether the operator head has moved vertically (step S43).

When determining that the operator head has not moved vertically (NO in step S43), the skill calculator 13 determines that no irrelevant action has occurred (step S44). When determining that the operator head has moved vertically (YES in step S44), the skill calculator 13 determines whether HYi−HYi−1>0 (step S45). When HYi−HYi−1>0 (YES in step S45), the skill calculator 13 determines that a stretching action has occurred (step S46). When HYi−HYi−1>0 is not satisfied (NO in step S45), or in other words, when HYi−HYi−1<0, the skill calculator 13 determines that a squatting action has occurred (step S47).

When the determination has yet to be complete for the last irrelevant action in the operation task (NO in step S48), the AR content display device 1 returns to step S31 to repeat steps S31 to S48. When the determination has been complete for the last irrelevant action in the operation task (YES in step S48), the skill calculator 13 counts irrelevant actions performed in the operation task and calculates the rate of the irrelevant actions using Formula 3 (step S49).

The count of the irrelevant actions is described with reference to FIG. 4. FIG. 4 illustrates example count of each irrelevant action performed by the operator A in the task SEQ 1001 in the process SEQ 001. The task SEQ 1001 in the process SEQ 001 includes walking performed once, carrying performed once, and squatting performed three times by the operator A.

Referring back to FIG. 7, the skill calculator 13 performs, also for the model operation information about the model operator, steps S31 to S49 in a similar manner. In each step, the operator is replaced with the model operator. The skill calculator 13 calculates, as the skill level of the operator, the difference between the rate of each irrelevant action calculated based on the operation information and the rate of each irrelevant action calculated based on the model operation information and generates information indicating the irrelevant action-based skill level for each operation task in the process (step S50). A higher irrelevant action-based skill level indicates a lower skill level of the operator. The skill calculator 13 transmits the information indicating the irrelevant action-based skill level to the AR marker determiner 14 and ends the calculation process.

The AR content display device 1 according to the embodiment improves the efficiency of performing operations and learning skills by displaying AR content based on the skill level of an operator at sites at which operation instructions and skill training are provided by displaying AR content.

The memory capacity constraint indicated by Formula 13 can prevent the performance of an AR application from decreasing. The AR content display constraint indicated by Formula 14 can increase the visibility for the operator.

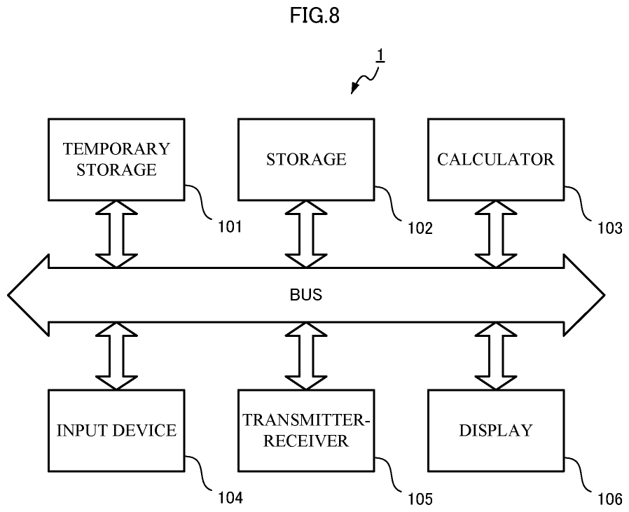

The hardware configuration of the AR content display device 1 is described with reference to FIG. 8. As illustrated in FIG. 8, the AR content display device 1 includes a temporary storage 101, a storage 102, a calculator 103, an input device 104, a transmitter-receiver 105, and a display 106. The temporary storage 101, the storage 102, the input device 104, the transmitter-receiver 105, and the display 106 are connected to the calculator 103 with a bus.

The calculator 103 is, for example, a central processing unit (CPU). The calculator 103 performs the processing of the operation information generator 11, the skill calculator 13, and the AR marker determiner 14 in accordance with a control program stored in the storage 102.

The temporary storage 101 is, for example, a random-access memory (RAM). The control program stored in the storage 102 is loaded to the temporary storage 101, and the temporary storage 101 is used as a work area for the calculator 103.

The storage 102 is a nonvolatile memory such as a flash memory, a hard disk, a digital versatile disc RAM (DVD-RAM), or a DVD rewritable (DVD-RW). The storage 102 prestores the program for causing the calculator 103 to perform the processing of the AR content display device 1, provides data stored in the program to the calculator 103 in accordance with an instruction from the calculator 103, and stores data provided from the calculator 103. The storage 12 is included in the storage 102.

The input device 104 includes an input device such as a keyboard, a pointing device, or a voice input device, and an interface device that connects the input device to the bus. Information input by a user is provided to the calculator 103 through the input device 104.

The transmitter-receiver 105 includes a network terminator or a radio communication device connected to a network, and a serial interface or a local area network (LAN) interface connected to the network terminator or the communication device. The transmitter-receiver 105 functions as the operation information generator 11 and the AR marker outputter 15.

The display 106 is, for example, a liquid crystal display (LCD) or an organic electroluminescent (EL) display. In a structure to directly input data into the AR content display device 1, the display 106 displays an input screen.

The processing of the operation information generator 11, the storage 12, the skill calculator 13, the AR marker determiner 14, and the AR marker outputter 15 in the AR content display device 1 illustrated in FIG. 1 is performed when the control program is executed using the temporary storage 101, the calculator 103, the storage 102, the input device 104, the transmitter-receiver 105, and the display 106 as resources.

The hardware configuration and the flowcharts are mere examples, and may be changed or modified as appropriate.

The main components that perform the processing of the AR content display device 1 including the calculator 103, the temporary storage 101, the storage 102, the input device 104, the transmitter-receiver 105, and the display 106 can be implemented with a typical computer system, rather than with a dedicated system. For example, a computer program for performing the above operations may be stored in a non-transitory computer-readable recording medium such as a flexible disc, a compact disc read-only memory (CD-ROM), or a DVD-ROM for distribution, and may be installed on a computer to implement the AR content display device 1 that performs the above processing. In some embodiments, the computer program may be stored in a storage device included in a server device on a communication network such as the Internet, and may be downloaded by a common computer system to implement the AR content display device 1.

In the system with the above functions of the AR content display device 1 implementable partially by the operating system (OS) and partially by an application program or through cooperation between the OS and the application program, portions executable by the application program other than the OS may be stored in a non-transitory recording medium or a storage device.

The computer program may be superimposed on a carrier wave to be provided through a communication network. For example, the computer program may be posted on a bulletin board system (BBS) on the communication network to be provided through the communication network. The computer program may be activated and executed under the control of the OS in the same manner as another application program to perform the above processing.

In the above embodiment, the AR marker determiner 14 determines the AR marker to be assigned to an operation task to satisfy the memory capacity constraint indicated by Formula 13 or the AR content display constraint indicated by Formula 14 and maximize the objective function. In some embodiments, the AR marker determiner 14 may determine the AR marker to be assigned to an operation task to satisfy both constraints and maximize the objective function.

In the embodiment described above, AR content is displayed on a wearable device worn by an operator to provide operation instructions and skill training at a manufacturing site. In some embodiments, the technique may be used at any site at which AR content is displayed on a wearable device worn by an operator. In this case, operation classes and irrelevant actions are defined as appropriate for the site.

In the flowchart described in the above embodiment, the operation class-based skill level calculation and the irrelevant action-based skill level calculation are performed in every process of displaying the AR content. In some embodiments, the operation class-based skill level calculation and the irrelevant action-based skill level calculation may be pre-performed to store the information indicating the operation class-based skill level and the information indicating the irrelevant action-based skill level into the storage 12.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2021-37344, filed on Mar. 9, 2021, the entire disclosure of which is incorporated by reference herein.

### REFERENCE SIGNS LIST

1 AR content display device
3 Wearable device
11 Operation information generator
12 Storage
13 Skill calculator
14 AR marker determiner
15 AR marker outputter
100 AR content display system
101 Temporary storage
102 Storage
103 Calculator
104 Input device
105 Transmitter-receiver
106 Display

1. An augmented reality content display device, comprising:
operation information generating circuitry to acquire image data from a wearable device worn by an operator and generate operation information indicating an operator action performed by the operator based on the image data, the wearable device being configured to display augmented reality content corresponding to an augmented reality marker;
a storage device to store the operation information, model operation information indicating an operator action performed by a model operator, and augmented reality marker information indicating an augmented reality marker;
skill calculating circuitry to calculate, as a skill level of the operator, based on a latest set of the operation information and the model operation information about a process including the operator action indicated by the operation information, a difference in the operator action between the operator and the model operator in each operation task in the process, and generate skill level information indicating the skill level of the operator;
augmented reality marker determining circuitry to determine an augmented reality marker to be assigned to each operation task in the process based on the skill level information; and
augmented reality marker outputting circuitry to output to the wearable device the augmented reality marker information indicating the augmented reality marker determined by the augmented reality marker determining circuitry.

2. The augmented reality content display device according to claim 1, wherein
the augmented reality marker determining circuitry determines the augmented reality marker to be assigned to each operation task in the process to satisfy a constraint on a number of items of augmented reality content displayed at a time.

3. The augmented reality content display device according to claim 1, wherein
the operation information generating circuitry detects position coordinates of objects including an article, and a head, an eye, and a hand of the operator in an image indicated by the image data, and generates the operation information including the position coordinates of the objects at predetermined time intervals.

4. The augmented reality content display device according to claim 1, wherein
the skill calculating circuitry determines, based on the latest set of the operation information and the model operation information about the process including the operator action indicated by the operation information, an operation class of the operator action performed by the operator and an operation class of the operator action performed by the model operator, and calculates, as the skill level of the operator, a difference between a rate of operator actions in the operation class performed by the operator in each operation task in the process and a rate of operator actions in the operation class performed by the model operator in each operation task in the process, and the operator actions in the operation class are a main operation, an auxiliary operation, a transporting operation, and pausing.

5. The augmented reality content display device according to claim 1, wherein
the skill calculating circuitry determines, based on the latest set of the operation information and the model operation information about the process including the operator action indicated by the operation information, an irrelevant action in the operator action performed by the operator and in the operator action performed by the model operator, and calculates, as the skill level of the operator, a difference between a rate of irrelevant actions performed by the operator in each operation task in the process and a rate of irrelevant actions performed by the model operator in each operation task in the process.

6. An augmented reality content display system, comprising:
a wearable device wearable by an operator, the wearable device being configured to display augmented reality content corresponding to an augmented reality marker; and
an augmented reality content display device comprising
operation information generating circuitry to acquire image data from the wearable device and generate operation information indicating an operator action performed by the operator based on the image data,
a storage device to store the operation information, model operation information indicating an operator action performed by a model operator, and augmented reality marker information indicating an augmented reality marker,
skill calculating circuitry to calculate, as a skill level of the operator, based on a latest set of the operation information and the model operation information about a process including the operator action indicated by the operation information, a difference in the operator action between the operator and the model operator in each operation task in the process, and generate skill level information indicating the skill level of the operator,
augmented reality marker determining circuitry to determine an augmented reality marker to be assigned to each operation task in the process based on the skill level information, and
augmented reality marker outputting circuitry to output to the wearable device the augmented reality marker information indicating the augmented reality marker determined by the augmented reality marker determining circuitry.

7. An augmented reality content display method, comprising:
acquiring image data from a wearable device worn by an operator and generating operation information indicating an operator action performed by the operator based on the image data, the wearable device being configured to display augmented reality content corresponding to an augmented reality marker;
calculating, as a skill level of the operator, based on a latest set of the operation information and model operation information indicating an operator action performed by a model operator about a process including the operator action indicated by the operation information, a difference in the operator action between the operator and the model operator in each operation task in the process, and generating skill level information indicating the skill level of the operator;
determining an augmented reality marker to be assigned to each operation task in the process based on the skill level information; and
outputting to the wearable device augmented reality marker information indicating the determined augmented reality marker.

8. (canceled)

9. The augmented reality content display device according to claim 2, wherein
the operation information generating circuitry-detects position coordinates of objects including an article, and a head, an eye, and a hand of the operator in an image indicated by the image data, and generates the operation information including the position coordinates of the objects at predetermined time intervals.

10. The augmented reality content display device according to claim 2, wherein
the skill calculating circuitry determines, based on the latest set of the operation information and the model operation information about the process including the operator action indicated by the operation information, an operation class of the operator action performed by the operator and an operation class of the operator action performed by the model operator, and calculates, as the skill level of the operator, a difference between a rate of operator actions in the operation class performed by the operator in each operation task in the process and a rate of operator actions in the operation class performed by the model operator in each operation task in the process, and the operator actions in the operation class are a main operation, an auxiliary operation, a transporting operation, and pausing.

11. The augmented reality content display device according to claim 3, wherein
the skill calculating circuitry determines, based on the latest set of the operation information and the model operation information about the process including the operator action indicated by the operation information, an operation class of the operator action performed by the operator and an operation class of the operator action performed by the model operator, and calculates, as the skill level of the operator, a difference between a rate of operator actions in the operation class performed by the operator in each operation task in the process and a rate of operator actions in the operation class performed by the model operator in each operation task in the process, and the operator actions in the operation class are a main operation, an auxiliary operation, a transporting operation, and pausing.

12. The augmented reality content display device according to claim 2, wherein
the skill calculating circuitry determines, based on the latest set of the operation information and the model operation information about the process including the operator action indicated by the operation information, an irrelevant action in the operator action performed by the operator and in the operator action performed by the model operator, and calculates, as the skill level of the operator, a difference between a rate of irrelevant actions performed by the operator in each operation task in the process and a rate of irrelevant actions performed by the model operator in each operation task in the process.

13. The augmented reality content display device according to claim 3, wherein
the skill calculating circuitry determines, based on the latest set of the operation information and the model operation information about the process including the operator action indicated by the operation information, an irrelevant action in the operator action performed by the operator and in the operator action performed by the model operator, and calculates, as the skill level of the operator, a difference between a rate of irrelevant actions performed by the operator in each operation task in the process and a rate of irrelevant actions performed by the model operator in each operation task in the process.

14. The augmented reality content display device according to claim 4, wherein
the skill calculating circuitry determines, based on the latest set of the operation information and the model operation information about the process including the operator action indicated by the operation information, an irrelevant action in the operator action performed by the operator and in the operator action performed by the model operator, and calculates, as the skill level of the operator, a difference between a rate of irrelevant actions performed by the operator in each operation task in the process and a rate of irrelevant actions performed by the model operator in each operation task in the process.
